(19) United States
(12) Patent Application Publication
(10) Pub. No.: US 2018/0369997 A1
(43) Pub. Date: Dec. 27, 2018

(54) CHUCK ASSEMBLY

(71) Applicant: Yi-Fu Chen, Taichung City (TW)

(72) Inventor: Yi-Fu Chen, Taichung City (TW)

(21) Appl. No.: 15/630,963

(22) Filed: Jun. 23, 2017

(51) Int. Cl. B25B 13/46

(52) U.S. Cl. CPC B25B 13/463; B23B 31/12

(57) ABSTRACT

A chuck assembly includes a chuck having a cross-shaped installation hole defined therethrough. A toothed disk is connected to the chuck and exposed from the outer periphery of the chuck. A driving unit includes a shaft and a gear which is mounted to the shaft. The driving unit is installed in the installation hole. The shaft includes two threaded sections respectively formed on two ends thereof. Two pawls each have threaded hole which is threadedly connected to the threaded section of the shaft corresponding thereto. When the gear is rotated to rotate the shaft, the two threaded sections are rotated to move the two pawls to move toward each other or away from each other.

### BACKGROUND OF THE INVENTION

### 1. Fields of the Invention

The present invention relates to a chuck assembly, and more particularly, to a chuck assembly that is able to quickly clamp objects of different sizes.

### 2. Descriptions of Related Art

There are different types of hand tools for performing different. functions and features so that the users can choose proper tools to assemble or dis-assemble products even having a complicated structure. Nevertheless, the existed hand tools can only perform a single function, therefore the users have to prepare different hand tools in the tool box to deal with different tasks. The tool box with many hand tools is heavy and bulky, and the hand tools have different lengths which may not suitable for being used in a narrow space.

The present invention intends to provide a chuck assembly which can be cooperated with a hand tool such as a wrench so as to quickly clamp objects of different sizes.

### SUMMARY OF THE INVENTION

The present invention relates to a chuck assembly and comprises a chuck having an installation hole defined through the top and the bottom thereof. A toothed disk is connected to the chuck and exposed from the outer periphery of the chuck. A driving unit is installed in the installation hole and includes a shaft and a gear. The shaft is rotatably received in the installation hole, and the gear is mounted to the middle portion of the shaft. The shaft has two threaded sections respectively formed on two ends thereof. The gear includes multiple teeth which are partially exposed beyond the installation hole in the top of the chuck. Two pawls each have the first end thereof connected to one of the two ends of the shaft and located in the installation hole. Each pawl has the second end thereof extending beyond the installation hole in the bottom of the chuck. Each pawl has a threaded hole defined through the first end thereof and the threaded hole includes inner threads which are engaged with the threaded section corresponding thereto. When the gear is rotated, the shaft is rotated by rotation of the gear so as to move the two pawls toward each other or away from each other in the installation hole.

Preferably, the installation hole includes a first path and a second path which perpendicularly intersects the first path. The width of the first path is wider than that of the second path. The shaft extends axially in the first path. The gear is installed axially in the second path.

Preferably, the chuck includes two slots defined radially in the bottom thereof. Each slot is a T-shaped slot and includes a radial path and an axial path. Each pawl includes an installation portion and a clamp portion. The threaded hole is defined through the installation portion of each pawl. A ridge extends radially from each of the pawls and is located between the installation portion and the clamp portion. The two respective ridges of the two pawls are slidably inserted into the two respective radial paths. The clamp portions of the two pawl are located in the two respectively axial paths.

Preferably, each of the two pawls has a cone-shaped portion defined in the inside thereof.

Preferably, the chuck is installed to a head of a wrench.

Preferably, an axle extends through the chuck and the shaft, and the shaft is rotatable about the axle.

Preferably, a protector is received in the installation hole and located between the two pawls. The protector is located beneath the gear.

The user simply holds the chuck and rotates the gear to control the distance between the two pawls to clamp or release an object. The chuck can be easily cooperated with other hand tools.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the chuck assembly of the present invention;

FIG. 2 is an exploded view of the chuck assembly of the present invention;

FIG. 3 is a perspective view to show the chuck assembly of the present invention from a bottom angle;

FIG. 4 is a cross sectional view, taken along line IV-IV of FIG. 1;

FIG. 5 shows that the pawls move toward each other;

FIG. 6 shows that the pawls move away from each other;

FIG. 7 shows that the chuck assembly of the present invention is connected to a wrench;

FIG. 8 is another perspective view to show that the chuck assembly of the present invention is connected to a wrench, and

FIG. 9 is a cross sectional view, taken along line IX-IX of FIG. 1.

### DETAILED DESCRIPTION OF THE PREFERRED EMBODIMENT

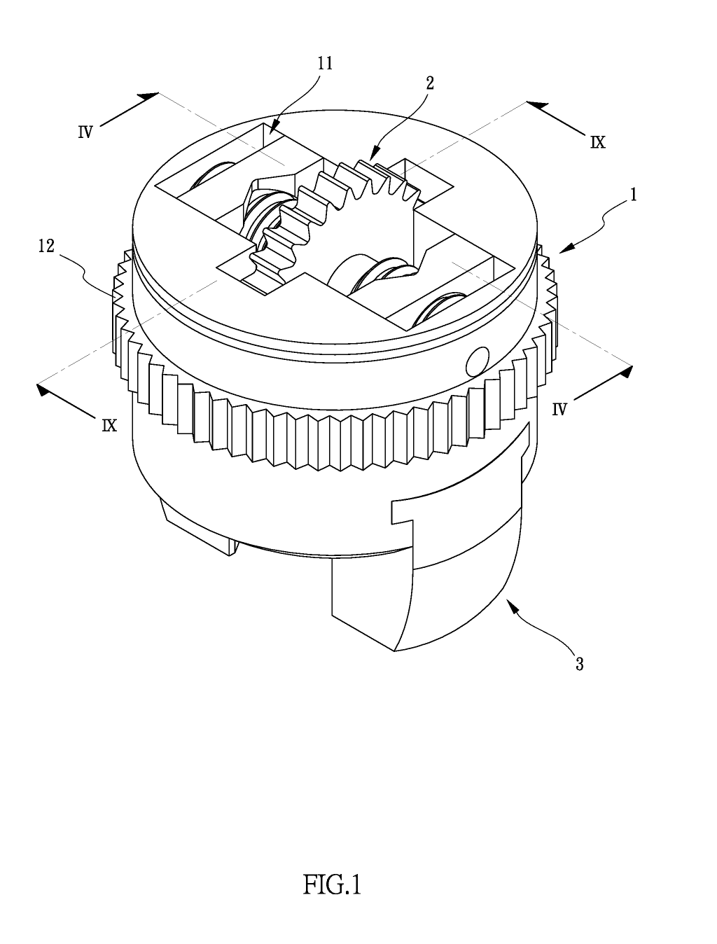

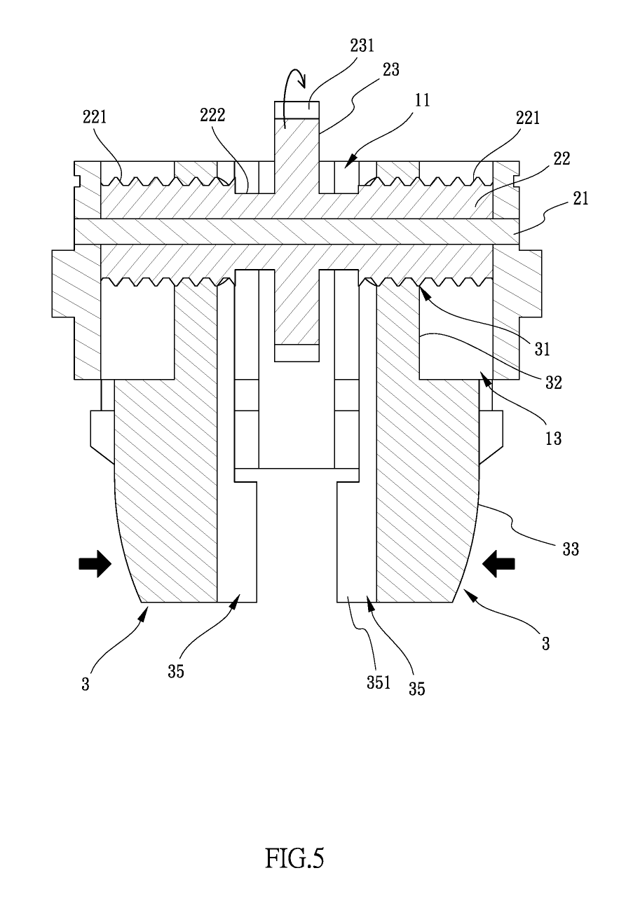

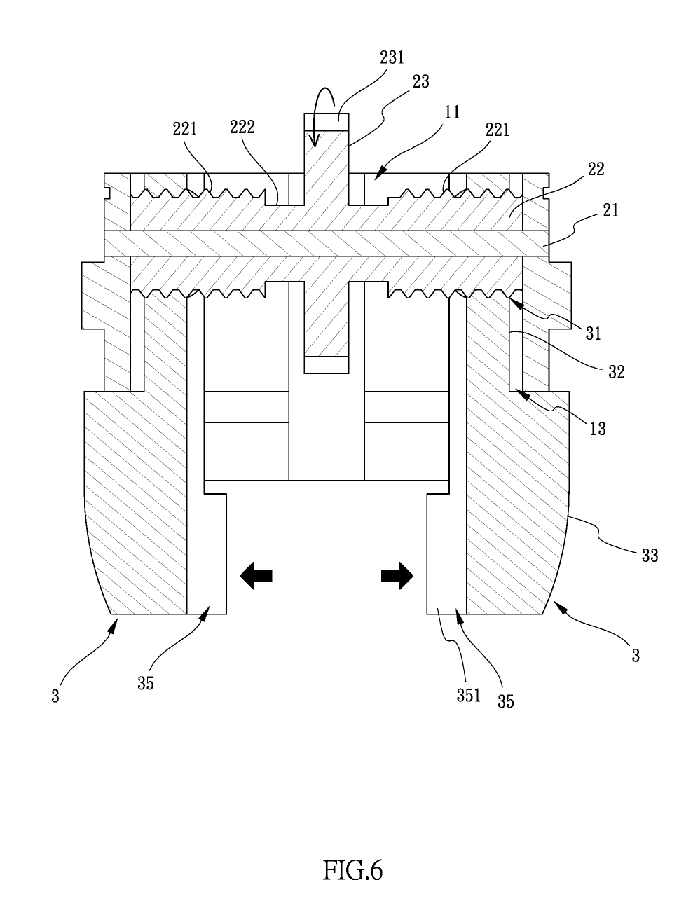

Referring to FIGS. 1 to 6, the chuck assembly of the present invention comprises a chuck 1 having an installation hole 11 defined through the top and the bottom thereof. A toothed disk 12 is connected to the chuck 1 and includes teeth which are exposed from the outer periphery of the chuck 1. The installation hole 11 includes a first path 111 and a second path 112 which perpendicularly intersects the first path 111 so that the installation hole 11 is a cross-shaped hole. The width “W” of the first path 111 is wider than the width “w” of the second path 112.

A driving unit 2 is installed in the installation hole 11 and includes an axle 21, a shaft 22 and a gear 23. The shall 22 includes a connection section 222 at the middle portion thereof and the gear 23 is mounted to the connection section 222 at the middle portion of the shaft 22. The shaft 22 extends axially in the first path 111, and the gear 23 is installed axially in the second path 112. The axle 21 extends through the chuck 1 and the shaft 22, and the shaft 22 is rotatable about the axle 21. The shaft 22 has two threaded sections 221 respectively formed on two ends thereof. The gear 23 includes multiple teeth 231 which are partially exposed beyond the installation hole 11 in the top of the chuck 1.

Two pawls 3 each have the first end thereof connected to one of the two ends of the shaft 22 and located in the installation hole 11. Each pawl 3 has the second end thereof extending beyond the installation hole 11 in the bottom of the chuck 1. Specifically, each pawl 3 includes an installation portion 32 and a clamp portion 33. A threaded hole 31 is defined through the installation portion 32 of each pawl 3. The threaded hole 31 includes inner threads 311 which are engaged with the threaded section 221 corresponding thereto. A ridge 34 extends radially from each of the pawls 3 and is located between the installation portion 32 and the clamp portion 33.

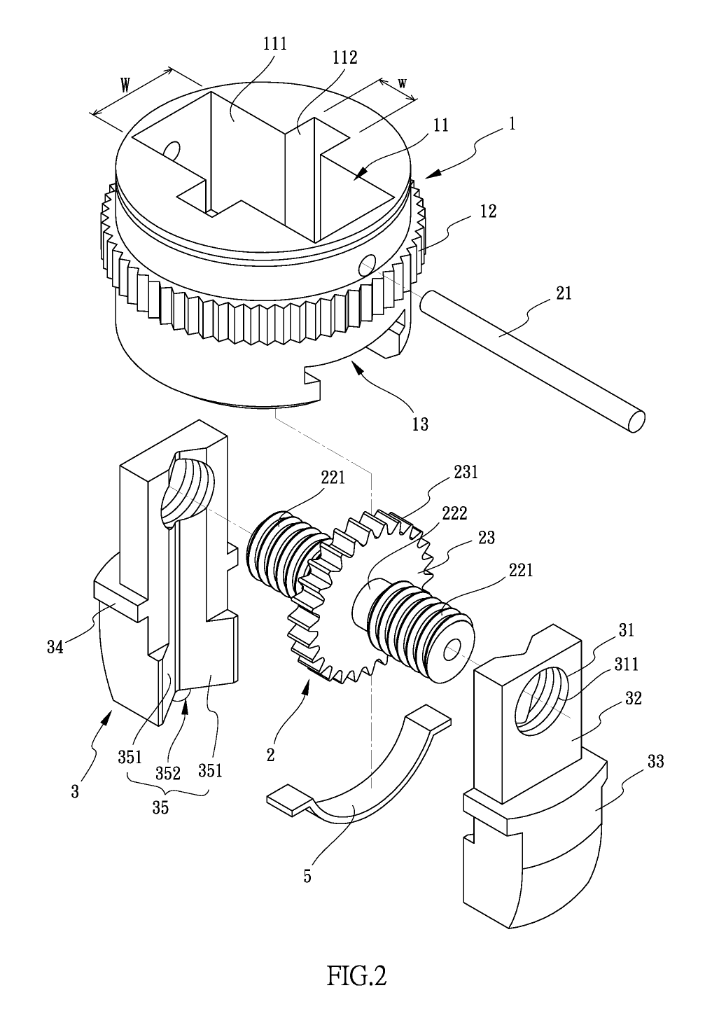

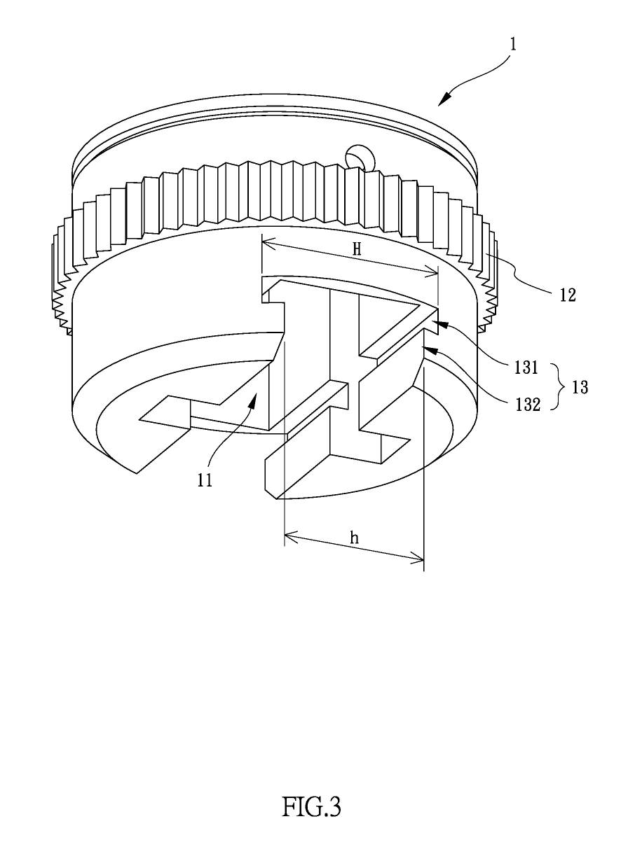

The chuck 1 includes two slots 13 defined radially in the bottom thereof Each slot 13 is a T-shaped slot and includes a radial path 131 and an axial path 132. The width “H” of the radial path 131 is wider than the width “h” of the axial path 132 as shown in FIG. 3. The two respective ridges 34 of the two pawls 3 are slidably inserted into the two respective radial paths 131. The ridges 34 ensure that the two pawls 3 are smoothly and steadily movable along the radial paths 131. The clamp portions 33 of the two pawl 3 are located in the two respectively axial paths 132. Each of the two pawls 3 has a cone-shaped portion 35 defined in the inside thereof. The cone-shaped portions 35 each include two faces 351 with an angle 352 defined therebetween. The cooperation of the two cone-shaped portions 35 can firmly clamp an object. As shown in FIG. 2, the shaft 22 and the gear 23 can be an integral piece or can be two separated parts.

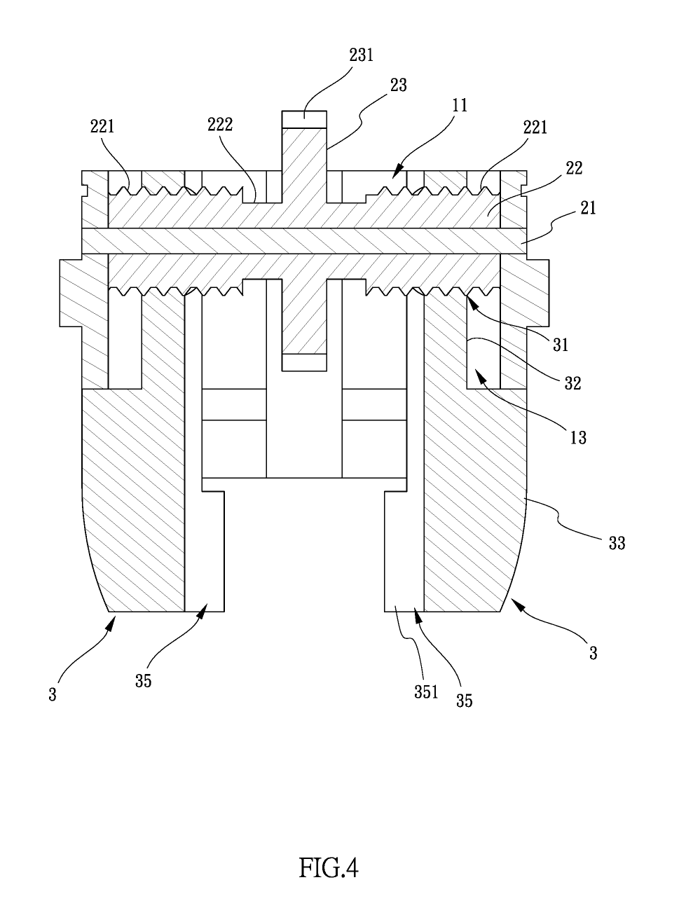

As shown in FIGS. 4 to 6, the users simply hold the chuck 1 by one hand and use the other hand to rotate the gear 23 so that the shaft 22 is rotated. The rotation of the shaft 22 drives the two pawls 3 to move toward each other or away from each other. The distance between the two pawls 3 is easily adjusted so as to clamp objects of different sizes. The gear 23 provide sufficient friction and the users can easily rotate the gear 23.

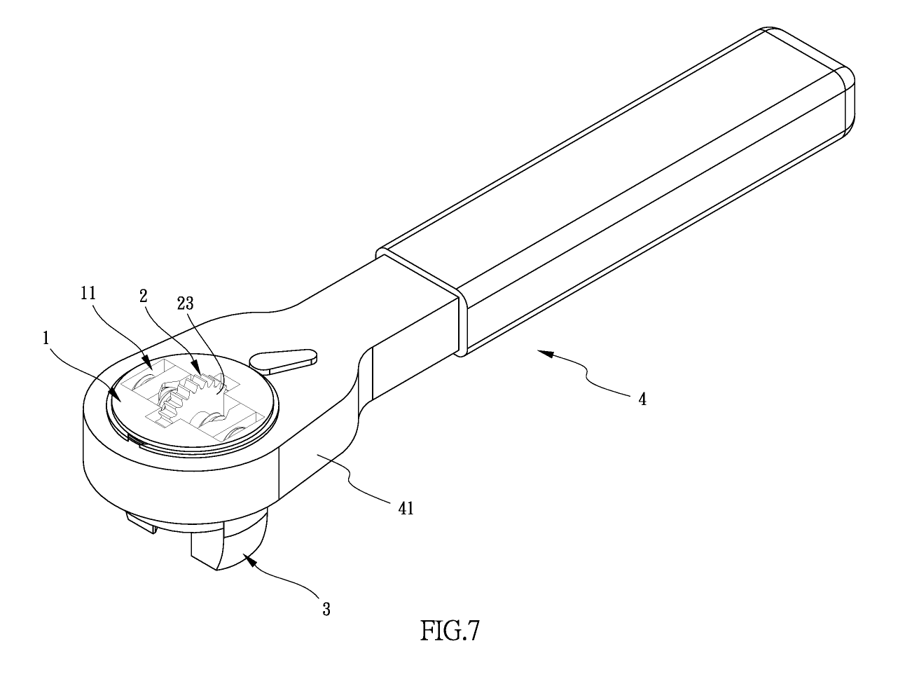

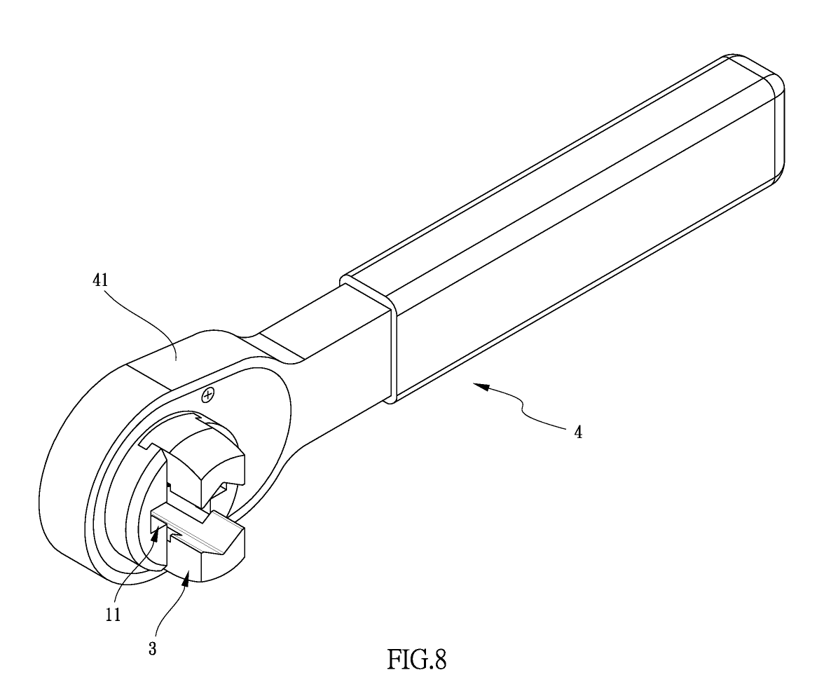

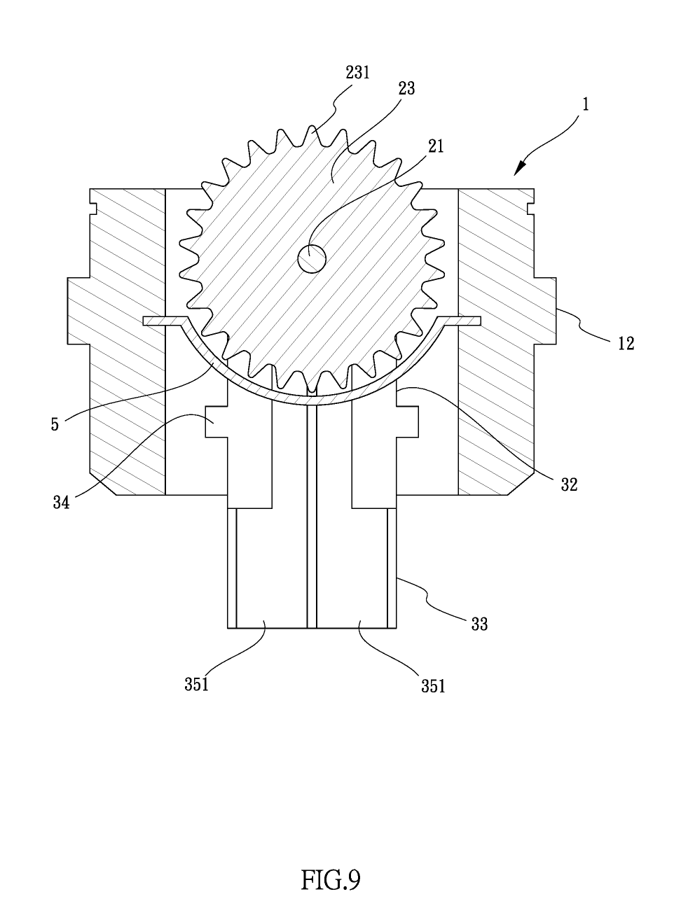

As shown in FIGS. 7 and 8, the chuck 1 can be installed to a head 41 of a wrench 4 or any known hand tool when needed. The chuck 1 can be connected with a socket, and the toothed disk 12 is engaged with the socket. As shown in FIGS. 2 and 9, a protector 5 is received in the installation hole 11 and located between the two pawls 3, and the protector 5 is located beneath the gear 23. The protector 5 is made of flexible material. The protector 5 protects the gear 23 from being hit by object clamped between the two pawls 3.

The chuck 1 is compact and easily operated. The chuck 1 may be used with a hand tool to expand the range of applications of the chuck 1.

While we have shown and described the embodiment in accordance with the present invention, it should be clear to those skilled in the art that further embodiments may be made without departing from the scope of the present invention.

1. A chuck assembly comprising:
a chuck (1) having an installation hole (11) defined through a top and a bottom thereof, a toothed disk (12) connected to the chuck (1) and exposed from an outer periphery of the chuck (1), the chuck (1) including two slots (13) defined radially the bottom thereof, each slot (13) being a T-shaped slot and including a radial path (131) and an axial path (132);
a driving unit (4) installed in the installation hole (11) and having a shaft (22) and a gear (23), the shaft (22) rotatably received in the installation hole (11), the gear (43) mounted to a middle portion of the shaft (22), the shaft (22) having two threaded sections (221) respectively formed on two ends thereof the gear (23) having multiple teeth (231) which are partially exposed beyond the installation hole (11) in the top of the chuck (1), and
two pawls (3) each having an installation portion (32) formed on a first end thereof, the installation portion (32) connected to one of the two ends of the shaft (22) and located in the installation hole (11), each pawl (3) having a clamp portion (33) formed on a second end thereof, the clamp portion (33) extending beyond the installation hole (11) in the bottom of the chuck (1), a ridge (34) extending radially from each of the pawls (3) and located between the installation portion (32) and the clamp portion (33), the two respective ridges (34) of the two pawls (3) slidably inserted into the two respective radial paths (131), the clamp portions (33) of the two pawl (3) located in the two respectively axial paths (132) each pawl (3) having a threaded hole (31) defined through the installation portion (32) thereof and the threaded hole (31) including inner threads (311) which are engaged with the threaded section (221) corresponding thereto, when the gear (23) is rotated, the shaft (22) is rotated by rotation of the gear (23) to move the two pawls (3) toward each other or away from each other in the installation hole (11).

2. The chuck assembly as claimed in claim 1, wherein the installation hole (11) includes a first path (111) and a second path (112) which perpendicularly intersects the first path (111), a width of the first path (111) is wider than a width of the second path (112), the shaft (22) extends axially in the first path (111), the gear (23) is installed axially in the second path (112).

3. (canceled)

4. The chuck assembly as claimed in claim 2, wherein the chuck (1) includes two slots (13) defined radially in the bottom thereof, each slot (13) is a T-shaped slot and includes a radial path (131) and an axial path (132), each pawl (3) includes an installation portion (32) and a clamp portion (33), the threaded hole (31) is defined through the installation portion (32) of each pawl (3), a ridge (34) extends radially from each of the pawls (3) and located between the installation portion (32) and the clamp portion (33), the two respective ridges (34) of the two pawls (3) are slidably inserted into the two respective radial paths (131), the clamp portions (33) of the two pawl (3) are located in the two respectively axial paths (132).

5. The chuck assembly as claimed in claim 1, wherein each of the two pawls (3) has a cone-shaped portion (35) defined in an inside thereof.

6. The chuck assembly as claimed in claim 5, wherein the chuck (1) is installed to a head (41) of a wrench (4).

7. The chuck assembly as claimed in claim 1, wherein an axle (21) extends through the chuck (1) and the shaft (22), the shaft (22) is rotatable about the axle (21).

8. The chuck assembly as claimed in claim 1, wherein a protector (5) is received in the installation hole (11) and located between the two pawls (3), the protector (5) is located beneath the gear (23).
